(19) United States
(12) Patent Application Publication
(10) Pub. No.: US 2021/0138627 A1
(43) Pub. Date: May 13, 2021

(54) TOOL BAG

(71) Applicant: Evan Euphrat, Santa Rosa, CA (US)

(72) Inventor: Evan Euphrat, Santa Rosa, CA (US)

(21) Appl. No.: 16/679,473

(22) Filed: Nov. 11, 2019

(51) Int. Cl. B25H 3/02

(52) U.S. Cl. CPC B25H 3/023

(57) ABSTRACT

The present invention is a new tool bag that opens in a manner to allow one or more walls of the tool bag to lie flat on a horizontal surface or to hang down freely over the edge of a horizontal surface and that individually stores tools and other useful items in a manner that will retain them if inverted. The tool bag comprises: a base, a back wall, two side walls, a front wall, releasably attached to the side walls, and a top, attached to the front wall and releasably attached to the side walls and back wall. The invention further comprises a MOLLE/PALS-type system used to attach various accessories for securing tools or other useful items. In some embodiments, the invention comprises panels containing MOLLE/PALS-type system that may be releasably attached to the interior surfaces of the tool bag.

### FIELD OF THE INVENTION

This invention relates to devices for secure organization and transport of various useful items, such as tools.

### BACKGROUND OF THE INVENTION

Devices for storing and transporting tools are well-known and include, tool boxes, tool bags, and tool belts. Tool boxes typically are constructed of rigid materials, such as metal, and often have a hinged lid, which when opened exposes an open compartment, wherein the tools are stored. In some prior art tool boxes, there are pockets on the exterior and/or interior surfaces of the tool box, which may separate and store various tools. These pockets generally do not secure items in such a way as to retain them if the pocket is inverted.

Prior art tool bags are generally constructed of less rigid materials than tool boxes, often made of cloth, leather, or other flexible materials, sometimes incorporating rigid or semi-rigid panels for support. Like some tool boxes, they may contain pockets that separate and store individual tools.

There is a need for a tool bag that will not only separate and store individual tools and other useful items, but will retain them in place if inverted, will open in a manner that allows one or more walls of the tool bag to lie flat on a horizontal surface or to hang down freely over the edge of a horizontal surface without spilling or otherwise losing its contents, and which enables the user to reconfigure or rearrange the features of the tool bag that enable storage of individual items.

### SUMMARY OF THE INVENTION

The general object of this invention is to provide a tool bag that opens in a manner to allow one or more walls of the tool bag to lie flat on a horizontal surface or to hang down freely over the edge of a horizontal surface and that individually stores tools and other useful items in a manner that will retain them if inverted. Further, the invention enables the user to configure various accessories in the tool bag in order to customize the configuration of tool storage. In some embodiments, removable panels may be employed in order to facilitate replacing one set of tools for another on pre-loaded panels.

The present invention is a new tool bag that comprises: a base, a back wall, two side walls, a front wall, releasably attached to the side walls, and a top, attached to the front wall and releasably attached to the side walls and back wall. The invention further comprises a MOLLE/PALS-type system used to attach various accessories for securing tools or other useful items. In some embodiments, the invention comprises panels containing MOLLE/PALS-type system that may be releasably attached to the interior surfaces of the tool bag.

These and other objects, advantages, and features of the invention are set forth in the detailed description, which follows.

### BRIEF DESCRIPTION OF THE DRAWINGS

FIG. 1 is a perspective view of one embodiment of the tool bag in a closed configuration.

FIG. 2 is a perspective view of one embodiment of the tool bag in an open configuration, showing the front wall and top lying flat on a horizontal surface.

FIG. 3 is a perspective view of one embodiment of the tool bag in an open configuration, showing the front wall lying flat on a horizontal surface and the top hanging vertically over the edge of said horizontal surface.

FIG. 4 is a perspective view of one embodiment of the tool bag in an open configuration, showing the front wall and the top hanging vertically over the edge of a horizontal surface.

### DETAILED DESCRIPTION OF THE INVENTION

The following description includes exemplary embodiments of the invention. This description is not to be taken in a limiting sense, but is meant only to illustrate the general principles of the invention. Various inventive features are described below that can each be used independently or in combination.

The invention is best understood by reference to the drawings. Referring first to FIGS. 1 and 2, an embodiment of the tool bag 10 of this invention comprises a base 20 with a back wall 30 attached to a first edge 25 of the base; a first side wall 40, adjacent to the back wall, and attached to a second edge 26 of the base, said second edge being adjacent to said first edge; a second side wall 50, adjacent to the back wall and opposite the first side wall, said second side wall attached to a third edge 27 of the base, said third edge being adjacent to the first edge and opposite the second edge; a front wall 60, flexibly attached to a fourth edge 28 of the base, said fourth edge being opposite the first edge and adjacent to each of said second and third edges, said front wall being releasably attached to vertical edges 45 and 55 of the first and second side walls; a top 70, flexibly attached to the front wall and releasably attached to top edges 46 and 56 of the first and second side walls; wherein a user can release the front wall and/or the top from the first and second side walls in order to access the interior surfaces of the tool bag. The top and front wall may be releasably attached to the side walls and back wall by any conventional means, including, but not limited to: zippers, snaps, or hook and loop fasteners. The tool bag further comprises one or more MOLLE-type attachment straps 80 and/or PALS-type webbing areas on the interior surface of each of the back wall, first and second side walls, front wall, and top.

As used herein, “MOLLE-type attachment straps” refer to Module Lightweight Load Carrying Equipment technology as exemplified in U.S. Pat. No. 5,724,707, issued Mar. 10, 1998. As used herein, “PALS-type webbing” refers to Pouch Attachment Ladder System, a well-known grid of webbing that is used to attach smaller equipment onto load-bearing platforms, such as vests and backpacks.

The MOLLE/PALS systems may be attached directly to the inside surfaces of the front, back, and side walls, and the top, or they may be attached to separate panels that may be releasably attached to those inside surfaces. If separate panels are employed, they may be releasably attached to the inside surfaces of the front, back, and side walls and the top by means of hook and loop fasteners, snaps, zippers, friction-fit, or any other attachment known in the art.

As shown in FIGS. 2-4, the attachment between the base and the front wall and the attachment between the front wall and the top are sufficiently flexible to enable a) the front wall and top to lie flat on a horizontal surface when released from the side walls and back wall (see FIG. 2); b) the front wall to lie flat on a horizontal surface and the top to hang vertically over the edge of said horizontal surface (see FIG. 3); or c) the front wall and the top to hang vertically over the edge of a horizontal surface upon which the base rests (see FIG. 4). Utilizing the MOLLE/PALS system, various pouches, clips, straps, ties, and other accessories may be secured to the inside surfaces of the tool bag in order to separate and securely store a wide variety of tools and other useful items. Further, certain of these accessories allow the stored tools and other items to remain secured in place even when inverted, such as when the front wall and/or top hang vertically over the edge of a horizontal surface.

The MOLLE/PALS system enables the user to utilize a variety of accessories to customize the arrangement of tools and items in the bag. The accessories may be removed, relocated, or replaced with other accessories as needed. Further, in embodiments in which the MOLLE/PALS system is attached to panels that are releasably attached to the interior surfaces of the bag, the user may employ a variety of panels that are pre-loaded with accessories and tools for various types of activities. By way of non-limiting example, one set of panels may be used to hold tools used for a plumbing job and a second set of panels may be used to hold tools for a carpentry job. With prior art tool bags, a user would either have to have a separate bag for each type of job, or would have to spend the time to remove one set of tools from the bag and add and arrange the second set of tools. The present invention saves the user time and frustration by simply removing one pre-loaded panel and replacing it with another, configured exactly to the user's preferences.

The tool bag may be carried by any conventional means including, but not limited to, shoulder straps, a handle attached to the top, or a handle attached to the side walls. The tool bag may be constructed of a wide variety of materials including, but not limited to metal, plastic, leather, or fabric. In some embodiments, the bag may be constructed of several materials, for example, the walls may be constructed of a plastic panels sandwiched between two layers of fabric. One of ordinary skill in the art would recognize that the selection of materials should reflect the desired balance of durability, comfort, and aesthetic appeal for any given embodiment of the invention.

Modifications and variations in the construction and arrangement of the tool bag disclosed herein can be made without departing from the subject and spirit of the invention. For example, the embodiment shown in the figures is shaped in a more or less rectangular configuration. One of ordinary skill in the art would recognize that other configurations are possible and such modifications and variations are within the scope of the invention.

I claim:

1. A tool bag comprising:
a base with a back wall attached to a first edge of the base;
a first side wall, adjacent to the back wall, and attached to a second edge of the base, said second edge being adjacent to said first edge;
a second side wall, adjacent to the back wall and opposite the first side wall, said second side wall attached to a third edge of the base, said third edge being adjacent to the first edge and opposite the second edge;
a front wall, flexibly attached to a fourth edge of the base, said fourth edge being opposite the first edge and adjacent to each of said second and third edges, said front wall being releasably attached to vertical edges of the first and second side walls;
a top, flexibly attached to the front wall and releasably attached to top edges of the first and second side walls;
wherein a user can release the front wall and/or the top from the first and second side walls in order to access the interior surfaces of the tool bag;
the tool bag further comprising an attachment system selected from MOLLE-type attachment straps and PALS-type webbing areas on the interior surface of each of the back wall, first and second side walls, front wall, and top.

2. The tool bag according to claim 1, wherein the attachment between the base and front wall and the attachment between the front wall and top are sufficiently flexible to enable the front wall and/or top to hang vertically over the edge of a horizontal surface on which the base rests.

3. The tool bag according to claim 1, wherein the interior surfaces of one or more of the back wall, first and second side walls, front wall, and top further comprises either the hook component or the loop component of a hook-and-loop engagement material.

4. The tool bag according to claim 1, wherein the interior surfaces of one or more of the back wall, first and second side walls, front wall, and top further comprises a plurality of either the male or female components of snap-type fasteners.

5. The tool bag according to claim 3, further comprising one or more removable panels sized to be compatible with the interior surfaces of the back wall, first and second side walls, front wall and/or top and wherein one surface of the one or more removable panels comprises either the hook component or the loop component of a hook-and-loop engagement material so as to enable the panels to be affixed to the interior surfaces of the tool bag by engaging with the corresponding component of the hook-and-loop engagement material thereon.

6. The tool bag according to claim 4, further comprising one or more removable panels sized to be compatible with the interior surfaces of the back wall, first and second side walls, front wall and/or top and wherein one surface of the one or more removable panels comprises a plurality of either the male or female components of snap-type fasteners so as to enable the panels to be affixed to the interior surfaces of the tool bag by engaging with the corresponding component of snap-type fasteners thereon.

7. The tool bag according to claim 1, further comprising one or more removable panels sized to be compatible with the interior surfaces of the back wall, first and second side walls, front wall and/or top and wherein such panels may be releasably affixed to said interior surfaces by friction fit.
